(19) United States
(12) Patent Application Publication
(10) Pub. No.: US 2009/0319349 A1
(43) Pub. Date: Dec. 24, 2009

(54) MOBILE MEMBER OPERATION METHOD

(75) Inventor: I Hung Wu, Taipei County (TW)

Correspondence Address: HUFFMAN LAW GROUP, P.C., 1900 MESA AVE., COLORADO SPRINGS, CO, 80906, US

(73) Assignee: VPON INC., Taipei County (TW)

(21) Appl. No.: 12/194,041

(22) Filed: Aug. 19, 2008

Related U.S. Application Data
(60) Provisional application No. 61/075,219, filed on Jun. 24, 2008.

(51) Int. Cl. G06Q 30/00

(52) U.S. Cl. 705/14.3

(57) ABSTRACT

The present invention provides a mobile member operation method suitable for a mobile electronic device, and the mobile electronic device is connected to a service server by a network. The mobile member operation method comprising: the mobile electronic device receives an update command. The mobile electronic device transmits the update command to the service server by the network. The service server determines that whether the user is a member and searches discount information by specific searching criteria, such as store location, industries, or other criteria, according to the update command. The service server transmits the discount information to the mobile electronic device for storing in a memory of the mobile electronic device if the user is a member. The mobile electronic device displays the discount information and receives a using command; and the mobile electronic device outputs the discount information.

### RELATED APPLICATIONS

This application claims the priority under 35 U.S.C. 119(e) to U.S. Provisional Application 61/075,219, entitled “ELECTRONIC DEVICE TESTING SYSTEM AND METHOD” filed Jun. 24, 2008, which is incorporated herein by reference in its entirety.

### FIELD OF THE INVENTION

The present invention relates to a member operation method, particularity relates to a mobile member operation method which using a mobile electronic device to output the discount information or bonus point.

### BACKGROUND OF THE INVENTION

Cooperation information of the specific store of store membership card or credit card usually is transmitted to the users through direct mail, web announcement and billboard announcement. The method of direct mail is the most normal communication method between the consumer and the banks or stores. The banks or stores mails the latest discount information printed on papers to the consumers. The consumers need to spend a lot of time to read the discount information after receiving the papers. However, the co-op relationship between the banks and stores usually changes. Therefore, the consumer may not find the changes in the papers and it will be an error while the consumer wants to use the discount.

With growing of the network, the banks or stores notifies the latest discount information on the web announcement. Then, the consumer need to find his discount information of all store membership card or credit card on the web announcement. However, the consumer can not get the discount information when he is outside. Although, the cell phone can connect to the network for searching web announcement, the transmitting cost of telecommunications will be expensive. The consumer can not use the discount information in a slipshod way.

The billboard announcement is the most effective method for the consumer. But the consumer needs to go to the store and read the discount information in front of the store. In other words, the consumer can not get any discount information without going to the store. Therefore, even if there may be no any goods that the consumer wants to buy, the consumer still needs to go to the store. In conclusion, the direct mail, web announcement and billboard announcement can not support the consumer any time.

### SUMMARY OF THE INVENTION

The present invention is directed to a mobile member operation method. Therefore the user can check and use his discount information or bonus point through the mobile electronic device any time without a physical membership card.

The present invention provides a mobile member operation method suitable for a mobile electronic device, and the mobile electronic device is connected to a service server by a network. The mobile member operation method comprising: the mobile electronic device receives an update command through an operation of an user; the mobile electronic device transmits the update command to the service server by the network; the service server determines that whether the user is a member and searches a discount information by a specific searching criteria according to the update command; the service server transmits the discount information to the mobile electronic device for storing in a memory of the mobile electronic device if the user is a member; the mobile electronic device displays the discount information and receives an using command; and the mobile electronic device outputs the discount information.

According to an embodiment of the present invention, the steps of the service server searches the discount information of the area stored in the storage of the service server according to the update command comprising: the service server determines that whether the discount information is ordered by a user through the mobile electronic device; the service server searches at least a membership card ordered by the user; the service server determines that whether at least the membership card is valid; and the service server searches the discount information according the to the update command if at least the membership card is valid.

According to an embodiment of the present invention, the mobile member operation method further comprising: the discount information is read and deleted after the mobile electronic device outputs the discount information.

The present invention also discloses a mobile member operation method suitable for a service server. The service server is connected to a mobile electronic device by a network, wherein the mobile electronic device transmits a register command, a basic data, an update command and a buying command to the service server. The mobile member operation method comprising receiving the register command and implementing the register command; determining that whether the user is registered; transmitting an application program to the mobile electronic device for installing if the user is not registered; receiving the basic data; determining that whether at least a membership card is selected according to the basic data; determining that whether a user is a present member of a store if at least the membership card is selected; storing the basic data if the user is the present member of the store; receiving the update command; searching a discount information by a specific searching criteria according to the update command; determining that whether the user is a member and transmitting the discount information to the mobile electronic device for storing in a memory of the mobile electronic device if the user is the member; determining that whether the buying command is received if the is not a member; and performing a buying procedure according to the buying command.

According to an embodiment of the present invention, wherein the steps of the service server searches the discount information by a specific searching criteria according to the update command comprising: the service server determines that whether the discount information is ordered by the user through the mobile electronic device; the service server searches at least the membership card ordered by the user; the service server determines that whether at least the membership card is valid; and the service server searches the discount information according to the update command if at least the membership card is valid.

The present invention also discloses a mobile member operation method suitable for a mobile electronic device, and the mobile electronic device is connected to a service server by a network. The mobile member operation method comprising: the mobile electronic device receives an displaying command and displays a user data; the user data is read by a store device; the store device transmits the user data to the service server for checking; the service server transmits a confirming code to the store device and mobile electronic device respectively; the service server transmits a bonus point to the mobile electronic device after checking the confirming code; the mobile electronic device receives an exchanging command and transmits the exchanging command to the service server after receiving the bonus point; and the service server deletes a exchanging point from the bonus point and transmits a notice to the mobile electronic device and the store device.

According to an embodiment of the present invention, the mobile member operation method further comprising: the mobile electronic device receives a register command; and the mobile electronic device transmits the register command to the service server for registering.

According to an embodiment of the present invention, the steps of the mobile electronic device transmits the register command to the service server for registering comprising: the service server determines that whether the user is registered; the service server transmits an application program to the mobile electronic device for installing if the user is registered; the mobile electronic device receives a basic data and transmits the basic data to the service server after installing; the service server determines that whether at least a membership card is selected; the service server determines that whether a user is a present member of a store if at least the membership card is selected; and the service server stores the register command.

According to an embodiment of the present invention, the steps of the mobile electronic device transmits the register command to the service server for registering further comprising: the service server determines that whether joining the membership card needs a special condition if the user is not the present member; joining the membership card if joining the membership card does not need the special condition; and the service server transmits the basic data to the store through the network for examining if joining the membership card needs the special condition.

### BRIEF DESCRIPTION OF THE DRAWINGS

FIG. 1 is a block diagram showing a mobile member operation system according to an embodiment of the present invention.

FIG. 2 shows a flow chart of the mobile member operation method according to an embodiment of the present invention.

FIG. 3 shows a flow chart of the mobile member operation method according to another embodiment of the present invention.

### DESCRIPTION OF EMBODIMENTS OF THE INVENTION

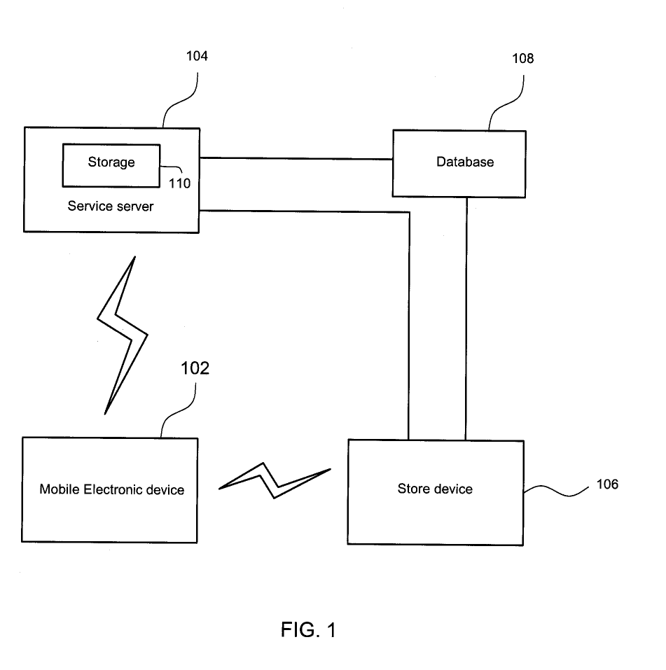

FIG. 1 is a block diagram showing a mobile member operation system according to an embodiment of the present invention. The mobile member operation system comprises a mobile electronic device 102, a service server 104 and a store device 106. The mobile electronic device 102 is connected to the service server 104 by a network. The mobile electronic device 102 is connected to the store device 106 by a network selectively. It will be apparent to one of the ordinary skill in the art that the network may be internet, a phone system, a radio frequency network, NFC (near field communication), infrared rays network or a Bluetooth network. However, it is not necessarily limited to it. And, the store device 106 can be a computer or POS (Point of sale) system.

Wherein, a database 108 is connected to the service server 104 and the store device 106. The database 108 may store the member's data so that the database 108 belongs to the stores or banks. Wherein, the store device 106 comprises storage 110.

In the preferred embodiment of the present invention, the mobile electronic device 102 is a laptop, cell phone, a personal digital assistant (PDA), a smart phone or a WAP-enable device. Besides, the network is wireless network.

In the preferred embodiment of the present invention, the service server 104 is disposed at a mobile service corporation which can integrate the stores (or the banks) to provide the mobile service. The service server 104 is connected to a database 108 for accessing a user data.

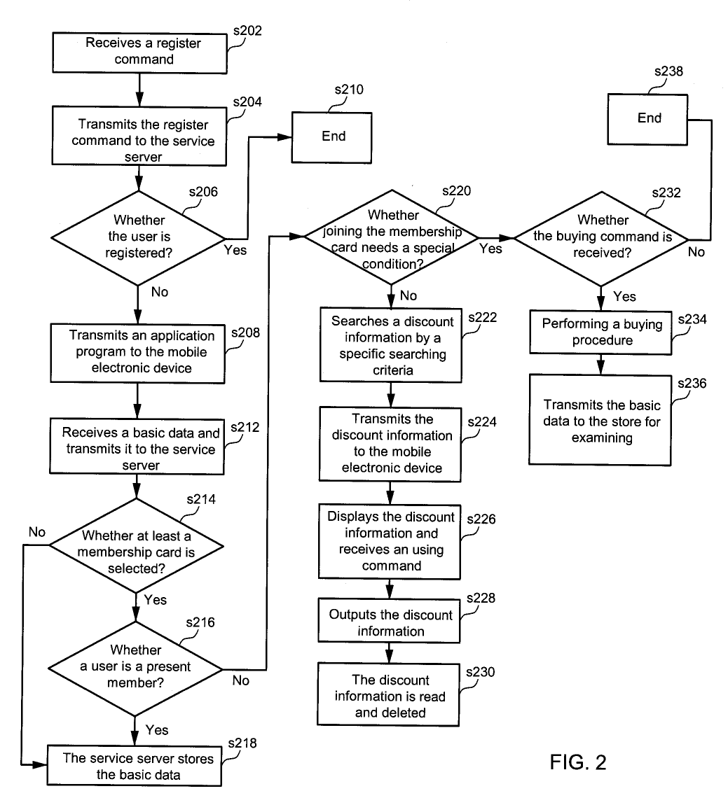

Referring to FIG. 2, it schematically shows a flow chart of the mobile member operation method according to an embodiment of the present invention. In the embodiment of the present invention, the mobile member operation method comprises the mobile electronic device 102 receives a register command inputted by a user (step 202). The register command is a special phone number which can connect to the service server 104.

Secondly, the mobile electronic device transmits the register command to the service server (step 204). Wherein, the register command is transmitted by a short message system. The service server 104 determines that whether the user is registered according to the phone number, Public key infrastructure, Digital Signature, International Mobile Equipment Identity code, user name, or identification number issued by the mobile electronic device 102 (step 206). Then, the service server 104 transmits an application program to the mobile electronic device 102 for installing if the user is not registered (step 208). Otherwise, the step will be terminated if the user is registered (step 210).

After receiving the application program, the application program will be installed in the mobile electronic device 102 automatically. Later, the mobile electronic device 102 receives a basic data and transmits the basic data to the service server 104 (step 212). It will be apparent to one of the ordinary skill in the art that the basic data may be a name, a communication address, the phone number, an age, an e-mail, and hobby or consuming history/preference of the user. However, it is not necessarily limited to it.

The service server 104 determines that whether at least a membership card is selected by the user (step 214).Wherein, the service server 104 can determine that whether at least a membership card is selected by the user according to the basic data. It will be apparent to one of the ordinary skill in the art that the membership card may be a store membership card

a credit card, a association card, or virtual organization member. However, it is not necessarily limited to it. The service server 104 stores the basic data if at least a membership card is selected by the user (step 218).

Then, the service server 104 determines that whether the user is a present member of a store according to the basic data if at least the membership card is selected (step 216). Therefore, the service server 104 determines that whether joining the membership card needs a special condition if the user is not the present member if the user is not the present member of a store according to the basic data (step 220). Wherein, the special condition may be that the user needs to pay some money for the membership card or accumulate a predetermined expenditure. However, it is not necessarily limited to it. The service server 104 determines that whether the buying command is received if the user is not a member (step 232). The service server 104 performs a buying procedure according the buying command (step 234). Wherein, the buying procedure including the user pay money via online paying and the money can be integrate into the credit card bill, cell phone bill, telephone bill or other online paying method. Then, the service server 104 transmits the basic data to the store for examining (step 236). If the buying command is received, the step will be terminated (step 238).

In the preferred embodiment of the present invention, the service server 104 also stores the basic data if the user is a present member of a store.

In the present invention, the service server 104 searches a discount information of an area stored in a storage 110 of the service server 104 according to the update command if the mobile electronic device 102 is the member (step 222). Wherein, update command comprises specific searching criteria, a predetermined area, an area selected by user or a present Global Positioning System (GPS) data or Assisted Global Positioning System (AGPS) data received by the mobile electronic device 102. Wherein, the specific searching criteria may be constellations, sex, blood type, habit, or interest. However, it is not necessarily limited to it.

In the preferred embodiment of the present invention, the steps of the service server 104 searches the discount information according to the update command may comprise the service server 104 determines that whether the discount information is ordered by the user through the mobile electronic device. In other words, the user can order predetermined discount information while registering. Furthermore, the service server 104 determines that whether at least the membership card is valid for the user. Then, the service server searches the discount information according to the update command if at least the membership card is valid. Otherwise, the user data will be recorded if at least the membership card is invalid.

The service server 104 transmits the discount information to the mobile electronic device 102. The mobile electronic device 102 stores the discount information in a memory of the mobile electronic device 102 (step 224). For example, the memory of the mobile electronic device 102 is Electrically Erasable Programmable Read-Only Memory, or Flash memory. However, it is not necessarily limited to it.

Hence, the user can browse the discount information in the mobile electronic device 102 and select the appropriate discount information. If the user does not like the discount information, he may update the discount information again. The mobile electronic device 102 receives a using command for the user selecting (step 226), i.e. user may need press confirm key to confirm selecting after selecting. The mobile electronic device 102 will output the discount information (step 228). Wherein, the output type may be transmitting the discount information to the store device 106 by the network or displaying the discount information on the display panel of the mobile electronic device 102 for store examining.

In the preferred embodiment of the present invention, the user may need to put the mobile electronic device 102 on the table of the store for reading. The waiter uses the store device 106 to read the output of the mobile electronic device 102, input the unique code displayed on the mobile device 102 on store device 106, or examine the output through his eyes.

In the present invention, the discount information can be read by scanner or the store device 106. The discount information is deleted from the memory of the mobile electronic device 102 when the discount information is read (step 230). It will be apparent to one of the ordinary skill in the art that the discount information may comprise a Bar code, QR code, a discount figure or a signal of WiFi, near field communication (NFC), radio frequency identification, or encoded audio frequency sound. However, it is not necessarily limited to it. Therefore, the deleted discount information can not be outputted again.

Wherein, based on scenario advertising, the mobile electronic device 102 outputs advertising which is related to the previous used discount content on mobile electronic device 102. For example, when checking out from karaoke at midnight, the mobile electronic device 102 or the service server 104 would determine the time and the store category, and suggest user to book a taxi to keep safety. Therefore, the mobile electronic device 102 or the service server 104 might show the taxi number following by the discount information. Such kind of scenario advertising can drive consumer's consuming behavior and provide the best suggestion and experience. However, the scenario advertising is not necessarily limited to this example.

In the preferred embodiment of the present invention, the discount information that is recommended by the service server based on user's consuming history, time, currently running campaign or any other information outputted.

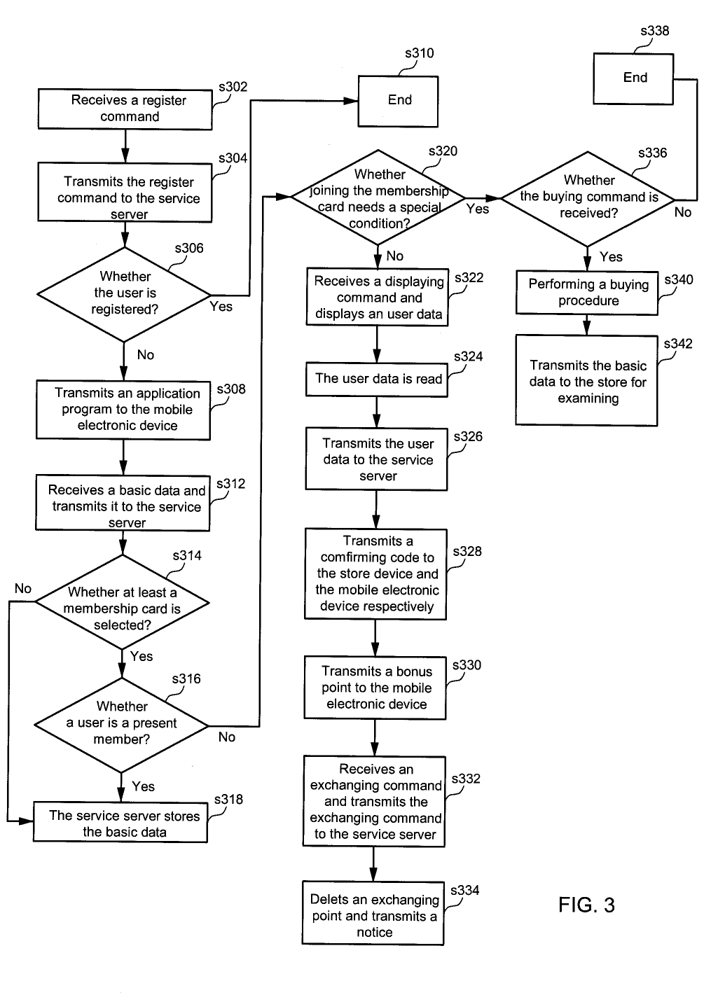

Referring to FIG. 3, it schematically shows a flow chart of the mobile member operation method according to another embodiment of the present invention. In the embodiment of the present invention, the mobile member operation method comprises the mobile electronic device 102 receives a register command inputted by a user (step 302). The register command contains a special phone number which can be used to identify the user or the mobile electronic device 102.

Secondly, the mobile electronic device transmits the register command to the service server (step 304). Wherein, the register command is transmitted by a short message system. The service server 104 determines that whether the mobile electronic device is registered according to the phone number, Public key infrastructure, Digital Signature, International Mobile Equipment Identity code, user name, or identification number issued by the mobile electronic device 102 (step 306). Then, the service server 104 transmits an application program to the mobile electronic device 102 for installing if the user is not registered (step 308). Otherwise, the step will be terminated if the phone number issued by the user is registered (step 310).

After receiving the application program, the application program will be installed in the mobile electronic device 102 automatically. Later, the mobile electronic device 102 receives a basic data and transmits the basic data to the service server 104 (step 312). It will be apparent to one of the ordinary skill in the art that the basic data may be a name, a communication address, the phone number, an age, an e-mail, and hobby of the user. However, it is not necessarily limited to it.

The service server 104 determines that whether at least a membership card is selected by the user (step 314).Wherein, the service server 104 can determine that whether at least a membership card is selected by the user according to the user basic data. It will be apparent to one of the ordinary skill in the art that the membership card may be a store membership card a credit card, a association card, or virtual organization member. However, it is not necessarily limited to it. The service server 104 stores the basic data if at least a membership card is selected by the user (step 318).

Then, the service server 104 determines that whether the user is a present member of a store according to the basic data if at least the membership card is selected (step 316). Therefore, the service server 104 determines that whether joining the membership card needs a special condition if the user is not the present member of a store according to the basic data (step 320). Wherein, the special condition may be that the user needs to pay some money for the membership card or accumulate a predetermined expenditure. However, it is not necessarily limited to it. The service server 104 determines that whether the buying command is received if the user is not a member (step 336). The service server 104 performs a buying procedure according the buying command (step 340). Wherein, the buying procedure including the user pay money via online paying and the money can be integrate into the credit card bill, cell phone bill, telephone bill or other online paying method. Then, the service server 104 transmits the basic data to the store for examining (step 342). If the buying command is received, the step will be terminated (step 338).

In the preferred embodiment of the present invention, the service server 104 also stores the basic data if the user is a present member of a store.

In the present invention, the mobile electronic device 102 receives a displaying command and displays a user data (step 322). It will be apparent to one of the ordinary skill in the art that the user data may comprise a Bar code, QR code, a discount figure, the phone number, the user name or a signal of WiFi, near field communication, radio frequency identification, or encoded audio frequency sound. However, it is not necessarily limited to it.

In the present invention, the user data can be read by the store device 106 (step 324). Wherein, the mobile electronic device 102 outputs another discount information outputted by the mobile electronic device 102. For example, the other promotion information may be automatically shown for users to dial the taxi number followed by the discount information if the discount information is related to any alcoholic drink. However, it is not necessarily limited to this scenario.

In the preferred embodiment of the present invention, the discount information that is recommended by the service server based on user's consuming history, time, currently running campaign or any other information outputted.

Furthermore, the user data can be read by the employees of the store. Then, the store device 106 transmits the user data to the service server 104 and the user data will be checked by the service server 104 (step 326). Wherein, the service server 104 will search a built-in user data stored in the storage of the service server 104 corresponding to the user data. If the user data is corresponding to built-in user data, the service server 104 transmits a confirming code to the store device 106 and the mobile electronic device 102 respectively. Thus, the store employee can check whether the confirming code of the mobile electronic device 102 and the confirming code of the store device 106 are the same. If the same, the worker of the store transmits a confirmed signal to the service server 104 through the store device 106 (step 328). Therefore, the service server 104 transmits bonus point to the mobile electronic device 102 (step 330).

After the mobile electronic device 102 receives the bonus point, the mobile electronic device 102 displays the bonus point on the display panel of the mobile electronic device 102 for the user. The user can input an exchanging command through the mobile electronic device 102 and the mobile electronic device 102 transmits the exchanging command to the service server 104 (step 332).

When the service server 104 receives the exchanging command, the deletes an exchanging point from the bonus point stored in the storage of the service server 104. Then, the service server 104 transmits a notice to the mobile electronic device and the store device for examining by the user and the employee of the store (step 334).

In the preferred embodiment of the present invention, the user can write a questionnaire on the mobile electronic device 102 and send the questionnaire to the service server 104 for analyzing.

The mobile member operation method of the present invention has several advantage:

(1) The mobile member operation method can record a time, a place and expenditure content of using the discount information or the bonus point. Therefore, the store and the bank can analyze the consumer's preference in an effective way.

(2) The mobile member operation method can transmit appropriate area discount information or the bonus point to the user. Therefore, the user can search the store according to administrative division, business area, subway station, rapid transit station, or other searching criteria.

(3) The mobile member operation method can support the sales promotion with limited budget of the store. It is because the discount information only can use for only one time and the discount information will be deleted after using.

While the present invention is disclosed by reference to the preferred embodiments and examples detailed above, it is to be understood that these embodiments and examples are intended in an illustrative rather than in a limiting sense. It is contemplated that modifications and combinations will readily occur to those skilled in the art, which modifications and combinations will be within the spirit of the invention and the scope of the following claims.

What is claimed is:

1-28. (canceled)

29. A method, comprising:
receiving a request for discount information over a network from a mobile electronic device, wherein the request comprises searching criteria;
determining whether a user associated with the mobile electronic device is a member;
if the user is a member:
searching for the discount information based on the searching criteria of the request; and
transmitting the discount information to the mobile electronic device;
wherein the discount information is usable for display on the mobile electronic device.

30. The method of claim 29, wherein the discount information is configured to be output by the mobile device to a vendor to utilize the discount information.

31. The method of claim 29, wherein said searching for the discount information comprises:
searching for at least a membership card of the user;
determining whether the at least the membership card is valid; and
searching for the discount information if the at least the membership card is valid.

32. The method of claim 31, wherein the membership card is a store membership card, a credit card, a corporation, a association card, or a virtual organization member.

33. The method of claim 31, wherein if the at least the membership card is invalid, the method comprises:
recording user data corresponding to the request.

34. The method of claim 29, wherein the discount information is usable for a single use and is deleted after display on the mobile electronic device.

35. The method of claim 29, wherein the discount information is usable for transmission to a store device by the mobile electronic device.

36. The method of claim 35, wherein the discount information is readable by the store device through infrared rays, Bluetooth radio frequency, WiFi, near field communication, radio frequency identification, or encoded audio frequency sound.

37. The method of claim 29, wherein said searching for the discount information is based on the user's consuming history, a current time, and/or a currently running campaign.

38. The method of claim 29, further comprising:
providing additional discount information to the user based on the request.

39. The method of claim 29, wherein the discount information comprises a Bar code, a QR code, a discount figure, or a signal of WiFi, near field communication, radio frequency identification, or encoded audio frequency sound.

40. The method of claim 29, wherein the request comprises Global Positioning System data or a phone number of the mobile electronic device.

41. The method of claim 29, wherein said receiving, said determining, said searching, and said transmitting are performed by a service server.

42. A method, comprising:
receiving a register command from a mobile electronic device over a network;
determining whether a user associated with the mobile electronic device is registered;
transmitting an application program to the mobile electronic device for installation, if the user is not registered;
receiving basic data from the mobile electronic device over the network;
determining whether at least a membership card is associated with the user based on the basic data;
determining whether the user is a member of one or more stores if the at least a membership card is associated with the user;
storing the basic data if the user is a member of the one or more stores;
receiving a request for discount information from the mobile electronic device over the network, wherein the request comprises searching criteria;
searching for the discount information using the searching criteria of the request;
transmitting the discount information to the mobile electronic device over the network if the user is a member of specific stores, brands, or banks associated with the discount information.

43. The method of claim 42, further comprising:
receiving a buying command from the mobile electronic device over the network;
determining whether obtaining a membership card requires a special condition if the user is not a member of the one or more stores;
if obtaining the membership card does not need the special condition:
signing up for the membership card;
performing a buying procedure according to the buying command; and
transmitting the basic data to the store through the Internet.

44. The method of claim 42, wherein said searching comprises:
determining whether the at least a membership card is valid; and
searching for the discount information if the at least a membership card is valid.

45. The method of claim 42, further comprising:
if the at least a membership card is invalid, recording the basic data.

46. The method of claim 42, wherein the discount information comprising a Bar code, a QR code, RFID, NFC, a discount figure, or encoded audio frequency sound.

47. The method of claim 42, wherein the request comprises Global Positioning System data and/or a phone number of the mobile electronic device.

48. The method of claim 42, wherein said determining whether the user is a member of the one or more stores comprises determining according to a phone number of the user, Public key infrastructure, Digital Signature, International Mobile Equipment Identity code, user name, or identification number of the user.

49. The method of claim 42, wherein the at least a membership card comprises a store membership card, a credit card, an association card, or virtual organization membership.

50. A method, comprising:
receiving user data from a store device, wherein the user data is provided from a mobile electronic device to the store device, wherein the user data corresponds to a user of the mobile electronic device;
determining if the user data is valid;
if the user data is valid:
providing a confirming code to the store device and the mobile electronic device respectively;
providing a bonus point to the mobile electronic device;
receiving an exchanging command from the mobile electronic device after said providing;
deleting an exchanging point from the bonus point; and
providing a notice to the mobile electronic device and the store device.

51. The method of claim 50, further comprising:
receiving a register command from the mobile electronic device.

52. The method of claim 51, further comprising:
determining whether the user is registered;
transmitting an application program to the mobile electronic device for installing if the user is registered;
receiving a basic data from the mobile electronic device;
determining whether at least a membership card is associated with the user;
determining whether the user is a member of a store based on the at least a membership card; and
storing the basic data.

53. The method of claim 52, further comprising:
if the user is not a member:
determining whether obtaining the at least a membership card requires a special condition;
applying for the membership card if joining the membership card does not need the special condition; and
transmitting the basic data to the store.

54. The method of claim 50, wherein the at least a membership card is a store membership card, a credit card, association card, or virtual organization membership.

55. The method of claim 50, wherein the user data is readable by a scanner, a store device through infrared rays, Bluetooth or radio frequency, WiFi, near field communication, radio frequency identification, encoded audio frequency sound.

56. The method of claim 50, further comprising:
providing another bonus point based on the user's consuming history, the current time, and/or a currently running campaign.

57. The method of claim 50, wherein the user data comprises a Bar code, or a QR code, or encoded audio frequency sound.

58. The method of claim 50, wherein the user data is a phone number of the user, Public key infrastructure, Digital Signature, International Mobile Equipment Identity code, user name, or identification number.
